(19) United States
(12) Patent Application Publication
(10) Pub. No.: US 2013/0163188 A1
(43) Pub. Date: Jun. 27, 2013

(54) ELECTRONIC DEVICE

(71) Applicants: Ping-Huei Lee, Taipei City (TW); Chih-Chiang Wang, Taipei City (TW); Pan-Jen Chen, Taipei City (TW); Tsung-Han Lin, Taipei City (TW); Ming-Wang Lin, Taipei City (TW); Hui-Lian Chang, Taipei City (TW); Yu-Hsuan Ku, Taipei City (TW)

(72) Inventors: Ping-Huei Lee, Taipei City (TW); Chih-Chiang Wang, Taipei City (TW); Pan-Jen Chen, Taipei City (TW); Tsung-Han Lin, Taipei City (TW); Ming-Wang Lin, Taipei City (TW); Hui-Lian Chang, Taipei City (TW); Yu-Hsuan Ku, Taipei City (TW)

(21) Appl. No.: 13/719,238

(22) Filed: Dec. 19, 2012

Related U.S. Application Data
(60) Provisional application No. 61/606,962, filed on Mar. 5, 2012.
(60) Provisional application No. 61/580,249, filed on Dec. 26, 2011.

(51) Int. Cl. G06F 1/16

(52) U.S. Cl. CPC G06F 1/1624
USPC 361/679.44

(57) ABSTRACT

An electronic device including a first body, a driving component, and a connector module is provided. The first body includes a main portion and an edge portion, wherein the thickness of the edge portion is smaller than the thickness of the main portion, and the edge portion has an opening. The driving component and the connector module are slidably disposed in the first body and so that the driving component drives the connector module to move from the main portion to the edge portion and the connector module is exposed from the opening of the edge portion.

### CROSS-REFERENCE TO RELATED APPLICATION

This application claims the priority benefits of U.S. provisional application Ser. No. 61/580,249, filed on Dec. 26, 2011 and U.S. provisional application Ser. No. 61/606,962, filed on Mar. 5, 2012. The entirety of each of the above-mentioned patent applications is hereby incorporated by reference herein and made a part of this specification.

### BACKGROUND

1. Field of the Invention

The present invention is directed to an electronic device and more particularly, an electronic device having a connector module capable of being hidden.

2. Description of Related Art

In recent years, with the advance of technology industries, electronic products including notebook computers, smart phones, and tablet computers have appeared frequently in everyday lives. Types and functions of the electronic products have become increasingly diverse, and convenience and practicality of these electronic products result in popularity thereof. The electronic products are equipped with connectors to connect external devices, such as external hard drives, network cables, power supplies, and so forth. These connectors are usually disposed on the outside of the electronic products, so that users may easily connect the external devices to the connectors.

However, the connectors disposed on the outside of the electronic products are exposed to the external environment for a long time and are thus likely to be contaminated by dust, which affects the functionality of the connectors. In addition, the connectors on the outside of the electronic products may pose a negative impact on the visual appearance of the electronic products. Hence, if the connectors not in use may be hidden, satisfactory functionality of the connectors and pleasant visual appearance of the electronic products may both be guaranteed.

In the related art, the exposed connectors may be covered by shielding structures (e.g., cover boards); however, users are required to remove the shielding structures by themselves while using the connectors and then place the shielding structures back to their original positions after using the connectors. The aforementioned manner leads to the inconvenient use of the connectors.

### SUMMARY

The present invention is directed to an electronic device having a hidden connector module for connecting with external devices.

The present invention is directed to an electronic device including a first body, a driving component and a connector module. The first body has a main portion and an edge portion, wherein a thickness of the edge portion is smaller than a thickness of the main portion, and the edge portion has an opening. The driving component and the connector module are slidably disposed in the first body, and the connector module is driven by the driving component to move from the main portion toward the edge portion, such that the connector module is exposed from the opening of the edge portion.

In an embodiment of the present invention, the connector module further includes a fixed sliding holder, a movable sliding holder, a circuit board and a connector. The fixed sliding holder is fixed to the first body and the movable sliding holder is slidably disposed on the fixed sliding holder. The circuit board is disposed on the movable sliding holder, and the connector is disposed on the circuit board.

In an embodiment of the present invention, the electronic device further includes at least one elastic component disposed between the fixed sliding holder and the movable sliding holder.

In an embodiment of the present invention, the electronic device further includes a stopper assembly located between the first body and the movable sliding holder. When the connector module is driven by the driving component to move toward the edge portion, the stopper assembly interferes with the movable sliding holder.

In an embodiment of the present invention, the stopper assembly further includes an elastic position-limiting portion located between the driving component and the movable sliding holder.

In an embodiment of the present invention, the electronic device further includes a cover assembly disposed in the first body and covering the opening of the edge portion.

In an embodiment of the present invention, the cover assembly has a repositioning elastic component and a cover, and the repositioning elastic component is linked between the cover and the first body.

In an embodiment of the present invention, the cover assembly has a cover, and the connector module has at least one first sliding portion. The cover has at least one second sliding portion corresponding to the at least one first sliding portions, and the at least one first sliding portion is slidably disposed in the second sliding portions.

In an embodiment of the present invention, the electronic device further includes a second body pivoted to the first body which has a keyboard disposed on the operating surface, and the second body has a display.

To sum up, in the electronic device of the present invention, the connector module is driven by the driving component to move from the main portion of the first body toward the edge portion, such that the connector module is exposed from the opening of the edge portion. In detail, the connector module is driven by the driving component to open or close the cover. When the driving component is moved from the first position to the second position, the cover is driven to turn from a closed position to an opened position. In addition, since the driving component and the movable sliding holder are linked with each other, and the connector module is disposed on the movable sliding holder, the movable sliding holder may be driven by the driving component when the driving component is moved from the first position to the second position, such that the connector module disposed on the movable sliding holder is synchronously pushed out of the first body for the user to use.

In order to make the aforementioned and other features and advantages of the present invention more comprehensible, several embodiments accompanied with figures are described in detail below.

### BRIEF DESCRIPTION OF THE DRAWINGS

The accompanying drawings are included to provide a further understanding of the present invention, and are incorporated in and constitute a part of this specification. The drawings illustrate embodiments of the present invention and, together with the description, serve to explain the principles of the present invention.

FIG. 1 is a three-dimensional (3D) schematic view showing an electronic device according to a first embodiment of the present invention.

FIG. 2 is a partial exploded schematic view showing the electronic device depicted in FIG. 1 in another viewing angle.

FIG. 3A is a partial schematic enlarged diagram showing part A of FIG. 1.

FIG. 3B is a partial enlarged schematic diagram showing part B of FIG. 1 in another viewing angle.

FIG. 4A is a partial 3D schematic diagram showing the driving component of FIG. 1 in an original position.

FIG. 4B is a partial 3D schematic diagram showing the driving component of FIG. 1 in a first position.

FIG. 4C is a partial 3D schematic diagram showing the driving component of FIG. 1 in a second position.

FIG. 4D is a partial 3D schematic diagram showing the driving component of FIG. 1 in a final position.

FIG. 5A is a partial schematic side view showing the cover of FIG. 1 in a closed position.

FIG. 5B is a partial schematic side view showing the cover FIG. 1 in an opened position.

FIG. 6 is a partial exploded schematic view showing an electronic device according to a second embodiment of the present invention.

FIG. 7A is a partial bottom view showing a driving component of FIG. 6 in a first position.

FIG. 7B is a partial bottom view showing the driving component of FIG. 6 in a transitional position.

FIG. 7C is a partial bottom view showing the driving component of FIG. 6 in a trigger position.

FIG. 7D is a partial bottom view showing the driving component of FIG. 6 in a second position.

FIG. 8 is a partial exploded schematic view showing an electronic device according to a third embodiment of the present invention.

FIG. 9A is a partial sectional view showing a driving component of FIG. 8 in a first position.

FIG. 9B is a partial sectional view showing the driving component of FIG. 8 in a trigger position.

FIG. 9C is a partial sectional view showing the driving component of FIG. 8 in a second position.

FIG. 10A is a partial side view showing a cover of an electronic device in a closed position according to a fourth embodiment of the present invention.

FIG. 10B is a partial side view showing the cover of the electronic device in an opened position according to a fourth embodiment of the present invention.

### DESCRIPTION OF EMBODIMENTS

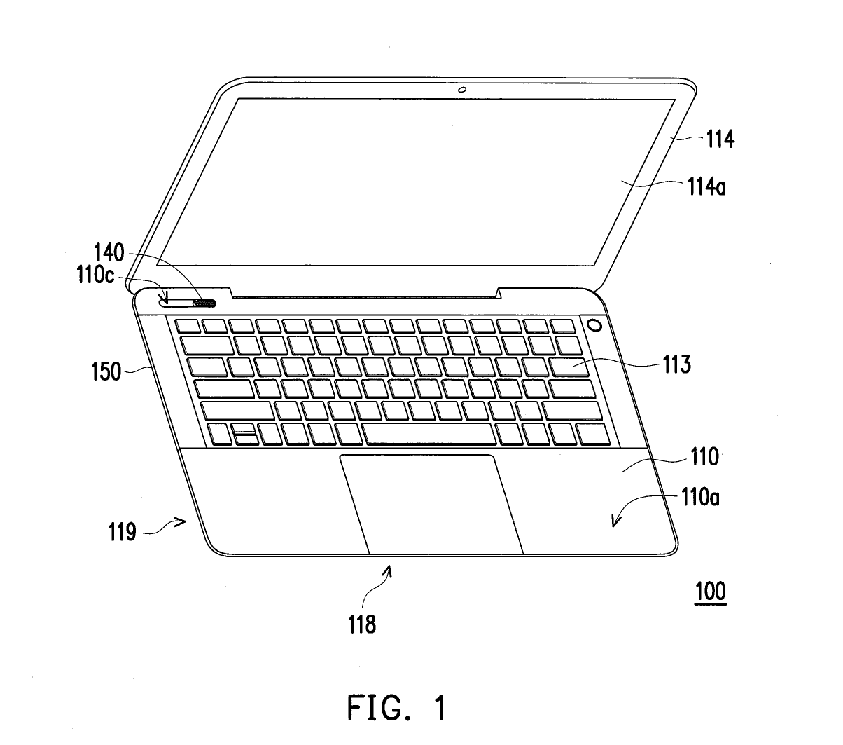

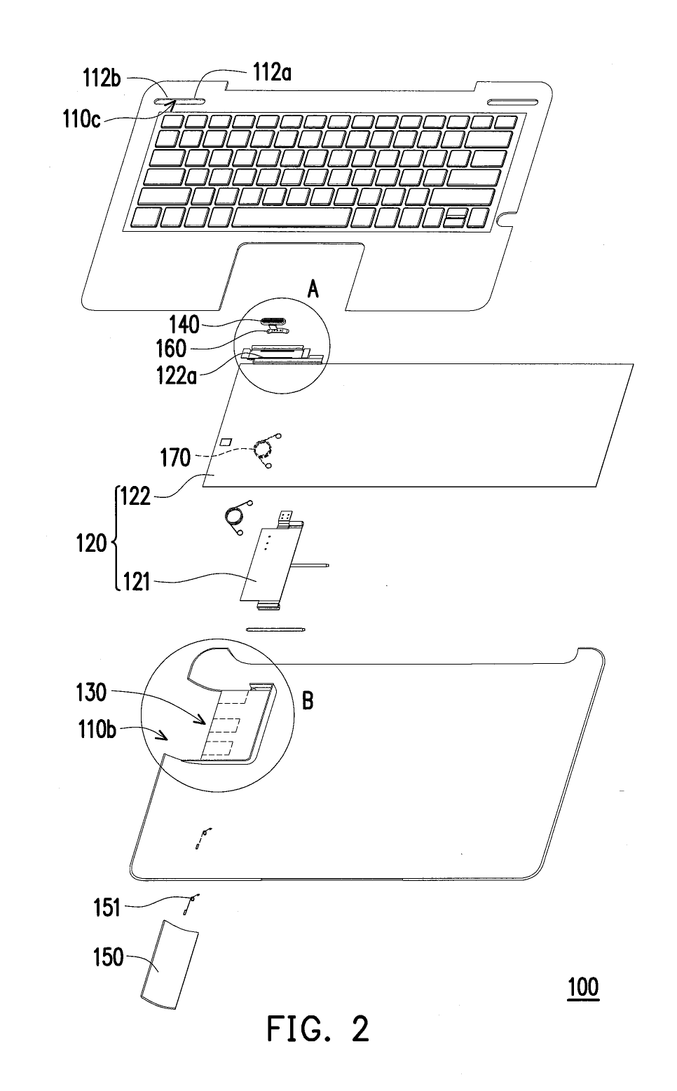

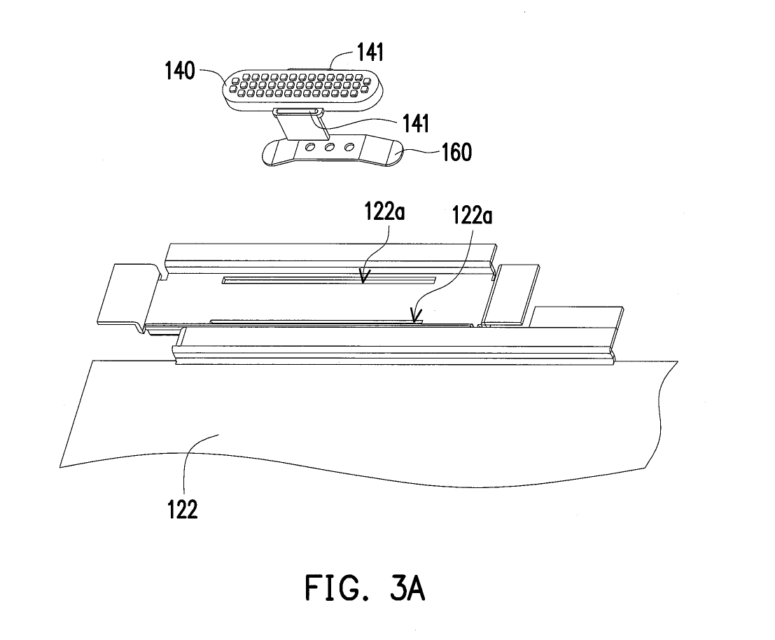

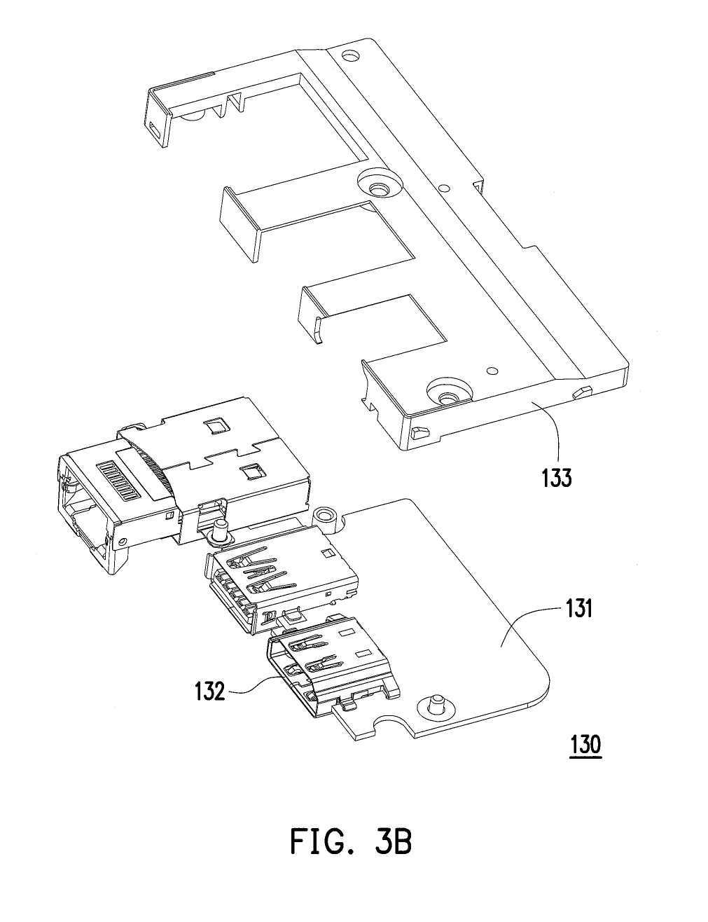

FIG. 1 is a three-dimensional (3D) schematic view showing an electronic device according to a first embodiment of the present invention. FIG. 2 is a partial exploded schematic view showing the electronic device depicted in FIG. 1 in another viewing angle. FIG. 3A is a partial schematic enlarged diagram showing part A of FIG. 1. FIG. 3B is a partial enlarged schematic diagram showing part B of FIG. 1 in another viewing angle. Referring to FIG. 1 through FIG. 3B, an electronic device 100 includes a first body 110, a slide assembly 120, a connector module 130, a driving component 140 and a cover 150. Referring to FIG. 1, the first body 110 has a main portion 118, an edge portion 119, an operating surface 110a and a second opening 110c. A thickness of the edge portion 119 is smaller than a thickness of the main portion 118. The edge portion 119 has a first opening 110b. The second opening 110c is disposed on the operating surface 110a. The driving component 120 includes a movable sliding holder 121 and a fixed sliding holder 122. The fixed sliding holder 122 is fixed to the first body 110, while the movable sliding holder 121 is slidably disposed on the fixed sliding holder 122.

As shown in FIG. 3B, the connector module 130 is disposed on the movable sliding holder 121. The connector module 130 includes a circuit board 131, a plurality of connectors 132 and a protection cover 133. In the connector module 130, the connectors 132 are disposed on the circuit board 131, the protection cover 133 covers the circuit board 131 and the connectors 132. The cover 150 covers the first opening 110b and is pivoted to the first body 110. Thus, all the connectors 132 of the present embodiment are covered by the cover 150 and thus, are not visible to a user from the external of the electronic device 100. The driving component 140 is adaptive to being assembled to the movable sliding holder 121 and move in the second opening 110c. In the present embodiment, the driving component 140 is slidably disposed in the first body 110. To be in detail, the driving component 140 is slidably disposed in two tracks 122a of the fixed sliding holder 122, and the tracks 122a are located within a range of the second opening 110c, and by a sliding manner, the driving component 140 may drive the connector module 130 to move form the main portion 118 of the first body 110 toward the edge portion 119 or from the edge portion 119 of the first body 110 toward the main portion 118.

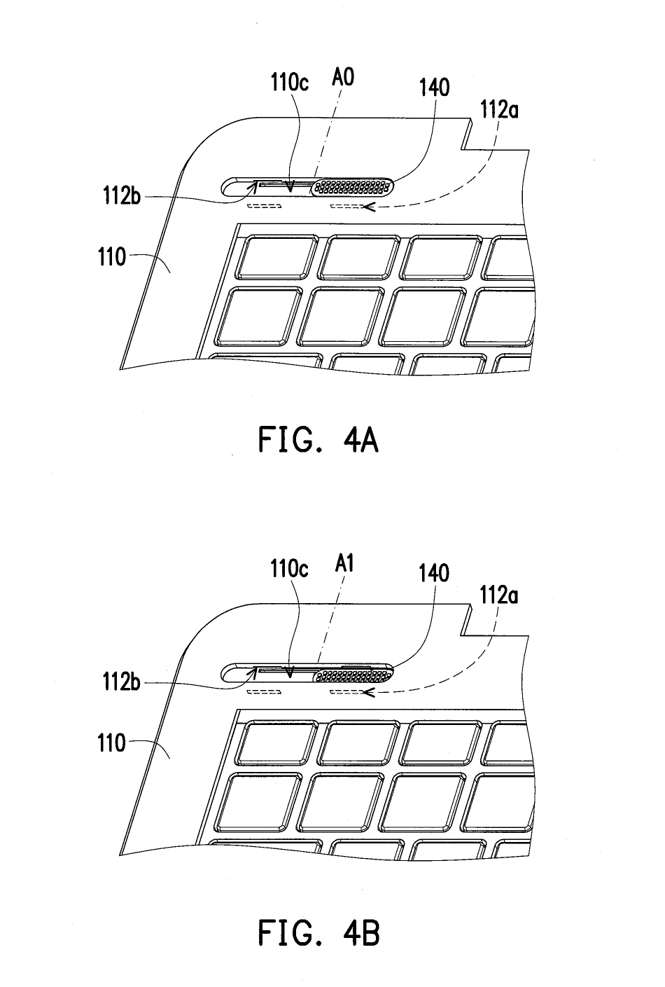

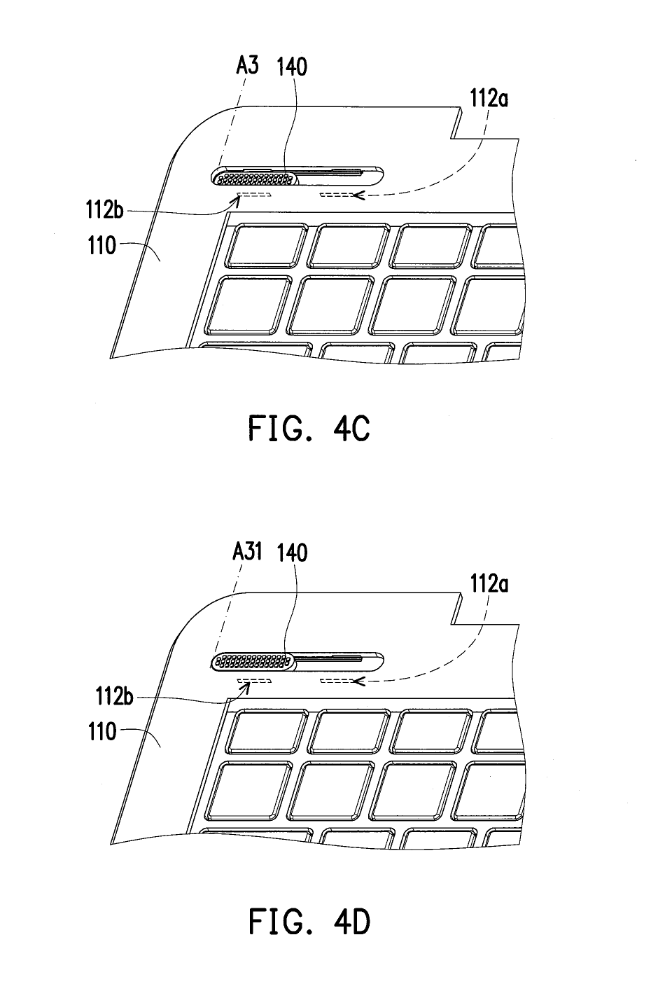

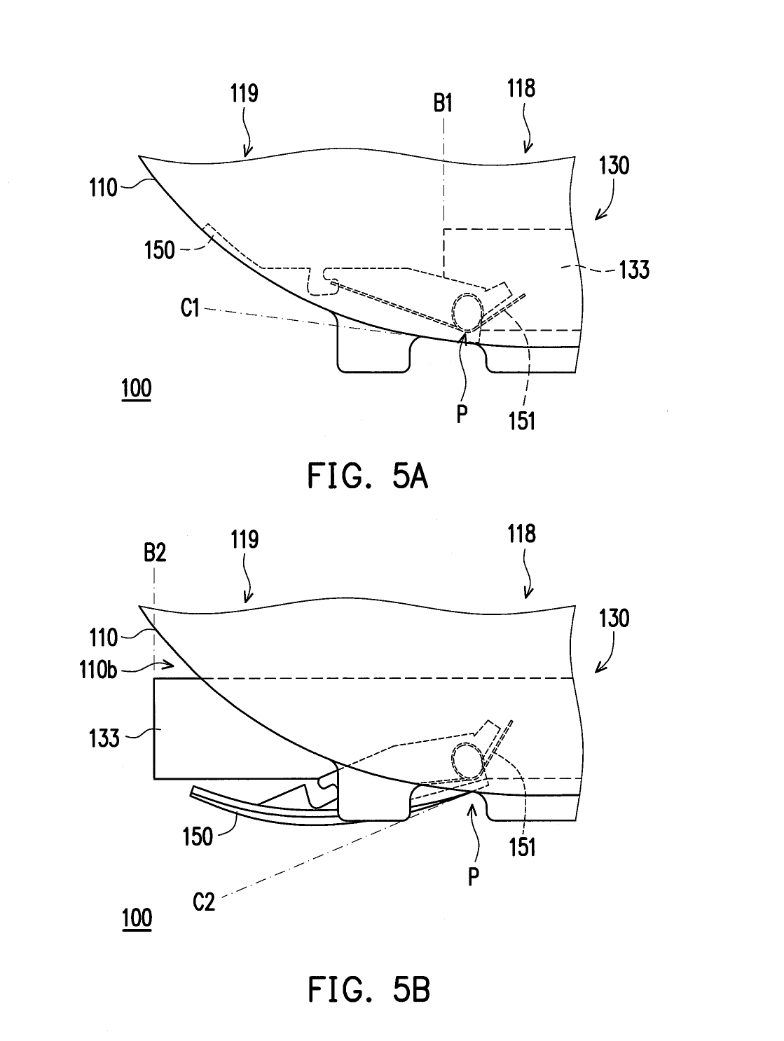

FIG. 4A is a partial 3D schematic diagram showing the driving component of FIG. 1 in an original position. FIG. 4B is a partial 3D schematic diagram showing the driving component of FIG. 1 in a first position. FIG. 4C is a partial 3D schematic diagram showing the driving component of FIG. 1 in a second position. FIG. 4D is a partial 3D schematic diagram showing the driving component of FIG. 1 in a final position. FIG. 5A is a partial schematic side view showing the cover of FIG. 1 in a closed position. FIG. 5B is a partial schematic side view showing the cover FIG. 1 in an opened position.

First, referring to FIG. 4B and FIG. 5A, when the driving component 140 is located in a first position A1, the connector module 130 is located in a retraction position B1, while the cover 150 is in a closed position C1. Then, referring to FIG. 4C and FIG. 5B with the exploded view of FIG. 2, when the driving component 140 is moved relative to the first body 110 from the first position A1 to a second position A3, since the driving component 140 is assembled on the movable sliding holder 121 of the driving component 120, the movable sliding holder 121 is driven to move with the driving component 140. Meanwhile, since the connector module 130 is disposed on the movable sliding holder 121, the connector module 130 is also driven as the movable sliding holder 121 is driven by the driving component 140. At this time, as shown in FIG. 5A and FIG. 5B, during the process of pushing, the connector module 130 is driven by the driving component 140 (not shown herein) to move from the main portion 118 toward the edge portion 119, so that the connector module 130 is exposed to the outside from the first opening 110b of the edge portion 119.

Thus, when the driving component 140 is moved from the first position A1 to the second position A3, the driving component 140 drives the movable sliding holder 121 so that the connector module 130 disposed on the movable sliding holder 121 is also pushed with the movable sliding holder 121, i.e. the connector module 130 is moved relative to the first body 110 from a retraction position B1 to a usage position B2. It is to be noticed that when the connector module 130 is moved form the retraction position B1 to the usage position B2, the protection cover 133 of the connector module 130 contacts the cover 150, applies a pushing force to the cover 150 and drives the cover 150 by such pushing force to turn relative to the first body 110 from a closed position C1 to an opened position C2 with a pivot axis P as a fulcrum. At this time, the connector module 130 is exposed from the first opening 110b of the edge portion 119 for the user to conveniently use one of the connectors 132. Additionally, in the present embodiment, the connector module 130 disposed on the movable sliding holder 121 is entirely driven to the usage position B2, and thus, the connectors 132 are pushed out together with the circuit board 131.

Thus, when operating the electronic device 100 of the present embodiment, the user pushes the driving component 140 to indirectly drive the connector module 130 on the driving component 120 and pushes the cover 150 by a contact force between the protection cover 133 of the connector module 130 and the cover 150 so as to open or close the cover 150. Such operation manner may substitute for the manner that the user manually opens the cover in the related art. In stead, the user opens or closes the cover 150 only by pushing the driving component 140 on the operating surface 110a, which results in good operability and convenience in usage

Referring to FIG. 2 and FIG. 3A, in the present embodiment, the driving component 140 includes two first position-limiting portions 141 (shown as one in FIG. 2) and the first body 110 includes four position-limiting portions 112, wherein two of the position-limiting portions 112a (shown as one in FIG. 2) correspond to the first position A1 of the driving component 140, while the other two of the position-limiting portions 112b (shown as one in FIG. 2) correspond to the second position A3 of the driving component 140. Additionally, the electronic device 100 further includes an elastic position-limiting portion 160 located between the driving component 140 and the driving component 120.

Further, referring to FIG. 4A, when the driving component 140 is located in its original position A0 the first position-limiting portion 141 of the driving component 140 is limited in the original position A0 corresponding to the position-limiting portion 112a of the first position A1. Then, referring to FIG. 4A and FIG. 4B, when the driving component 140 receives a pressure, the elastic position-limiting portion 160 (shown in FIG. 2) located between the first body 110 and the fixed sliding holder 122 is deformed so that the position-limiting relationship between the position-limiting portion 112a corresponding to the first position A1 and the first position-limiting portion 141 of the driving component 140 is dissolved, such that the driving component 140 may be moved from the original position A0 to the first position A1. Afterward, referring to FIG. 4C and FIG. 4D, when the driving component 140 is moved to the second position A3, the pressure is released and the first position-limiting portion 141 of the driving component 140 is limited in a final position A31 by the position-limiting portion 112b corresponding to the second position A3 so as to maintain the connector module 130 in the usage position B2.

Therefore, in the present embodiment, the driving component 140 is operated as follows. First, the driving component 140 is limited in the original position A0 (as shown in FIG. 4A) by the first position-limiting portion 141. Then, the driving component 140 receives a pressure, and at this time, the position-limiting relationship between the position-limiting portion 112a and the first position-limiting portion 141 of the driving component 140 is dissolved (as shown in FIG. 4B). Afterward, the driving component 140 is moved from the first position A1 to the second position A3 (as shown in FIG. 4C). Finally, the pressure is released, and the first position-limiting portion 141 of the driving component 140 is limited in the final position A31 by the position-limiting portion 112b (as shown in FIG. 4D).

Accordingly, in the present embodiment, when the driving component 140 is moved to the second position A3, the connector module 130 is moved to the usage position B2, at this time, the driving component 140 is limited by the position-limiting portion 112 of the first body 110, and thus, the movable sliding holder 121 assembled to the driving component 140 is also maintained in the original position. As such, the connector 132 may be prevented from being moved due to the insertion and extraction force occurring when the user plugs in or out the connector 132 so that the electronic device 100 is more stable.

Referring again to FIG. 2, in the present embodiment, the electronic device 100 further includes a plurality of elastic components 170 (shown as two in FIG. 2). The elastic components 170 are disposed between the fixed sliding holder 122 and the movable sliding holder 121. When the driving component 140 is moved to a trigger position, the elastic components 170 pops up the movable sliding holder 121 from the driving component 120 so that the connector module 130 is horizontally moved to the usage position B2. The trigger position is located after the first position A1, and during the popping-up process, the driving component 140 is maintained in the trigger position. In the present embodiment, the second position A3 is illustrated as an example of the trigger position, but the present invention is not limited thereto, and the trigger position may be between the first position A1 and the second position A3.

Moreover, when the user utilizes the driving component 140 to drive the movable sliding holder 121 and the driving component 140 is pushed to the trigger position, elastic potential energy of the elastic components 170 accumulated from the first position A1 to the second position A3 in the driving component 140 is released, and an elastic force generated therefrom may pops up the movable sliding holder 121. Thus, for the user, the electronic device 100 of the present embodiment not only has good operability, convenience and stability but also has a capability of automatically popping up the connector module 130.

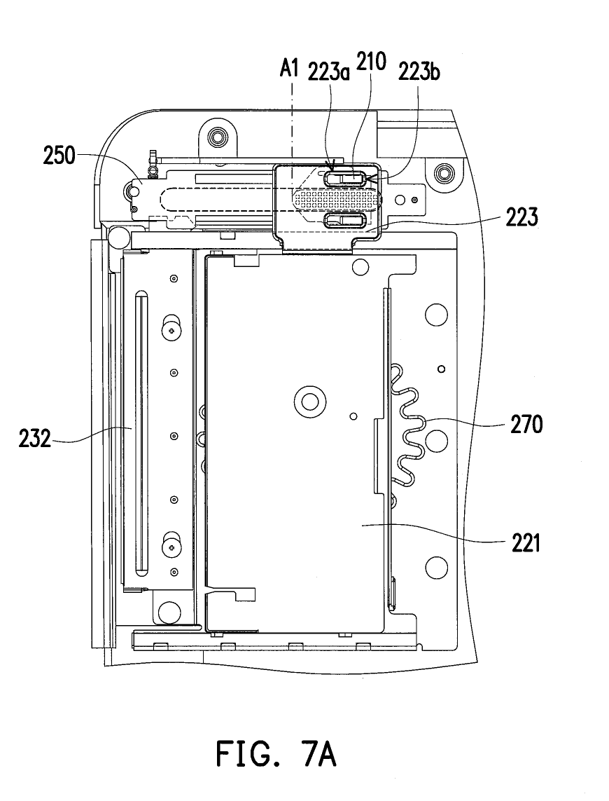

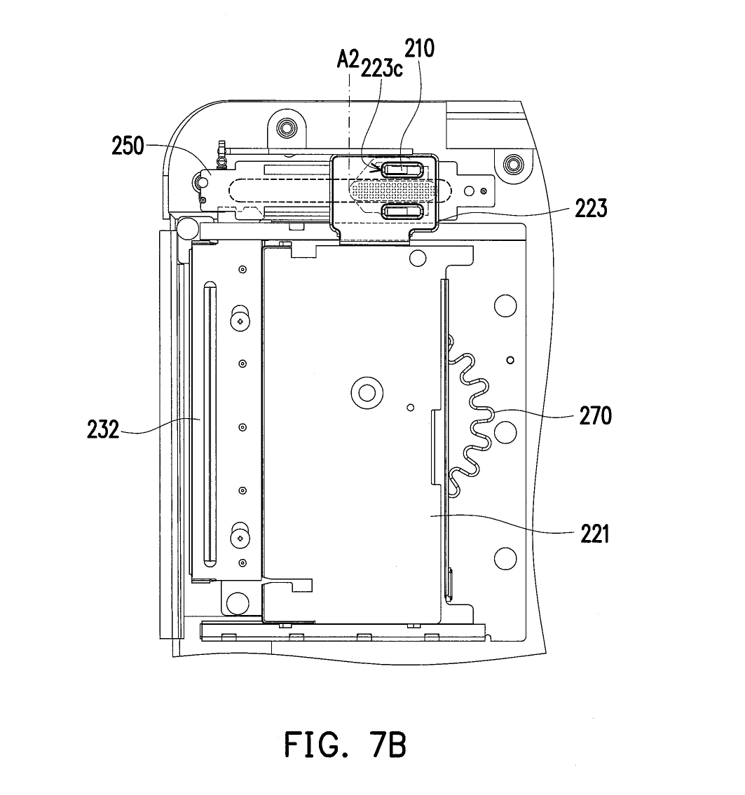

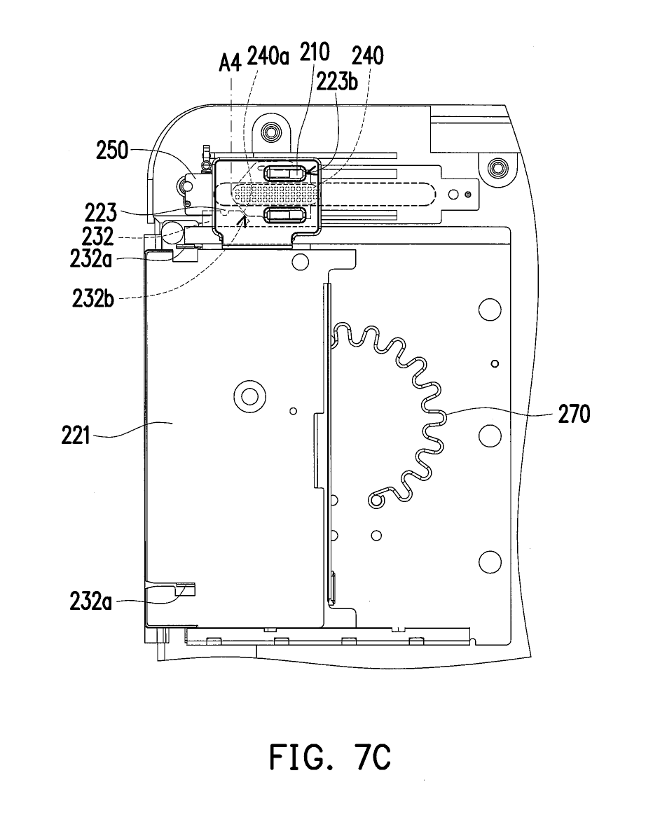

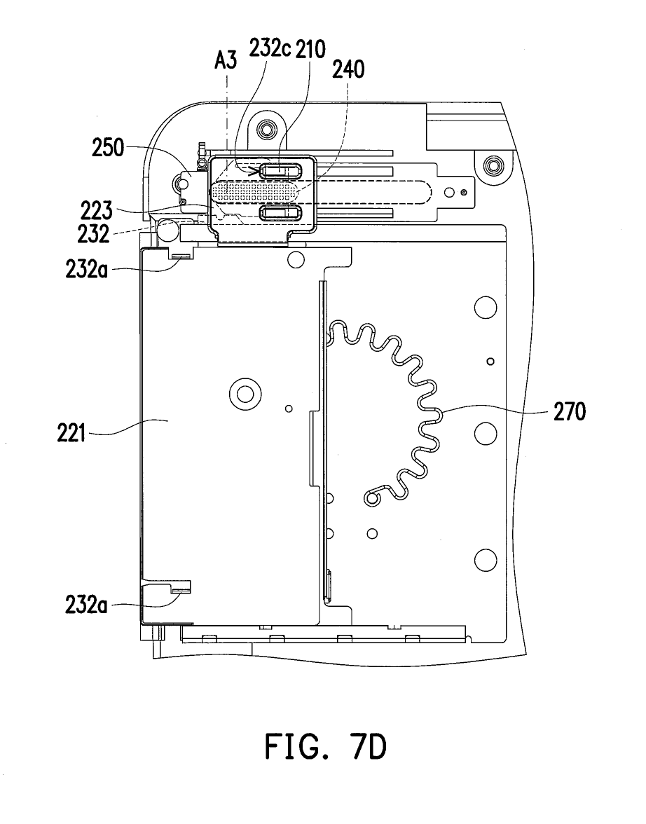

The position of each component and the feature of each component during the when component 140 of the electronic device 100 being moved from the first position A1 to the second position A3 have been described in detail in the above. If the user wishes to move the driving component 140 from the second position A3 to the first position A1, he/she only requires operating the above-described manner reversely by the following steps. First, a pressure is applied to the driving component 140 in the final position A31 to deform the elastic position-limiting portion 160 so that the position-limiting relationship between the position-limiting portion 112b and the driving component 140 is released, and the driving component 140 is moved to the second position A3. Then, the driving component 140 is moved from the second position A3 to the first position A1. When the driving component 140 is moved to the first position A1, such pressure is released so that the driving component 140 is limited in the original position A0 by the position-limiting portion 112a. Referring to FIG. 7, it is to be noticed that in the present embodiment, the cover 150 has a repositioning elastic component 151, such as a torsional spring. Thus, when the user pushes the driving component 140 from the second position A3 back to the first position A1, the repositioning elastic component 151 repositions the cover 150 relative to the first body 110 from the opened position C2 to the closed position C1.

Referring again to FIG. 1, as shown in FIG. 1, the electronic device 100 of the present embodiment further includes a second body 114. The second body 114 is pivoted to the first body 110, wherein the first body 110 has a keyboard disposed on the operating surface 110a for the user to input texts. The second body 114 has a display 114a capable of displaying screens viewed by the user. Thus, in the present embodiment, a notebook computer is illustrated as an example of the electronic device 100, and certainly, the present invention is not intent to limit the type of the electronic device.

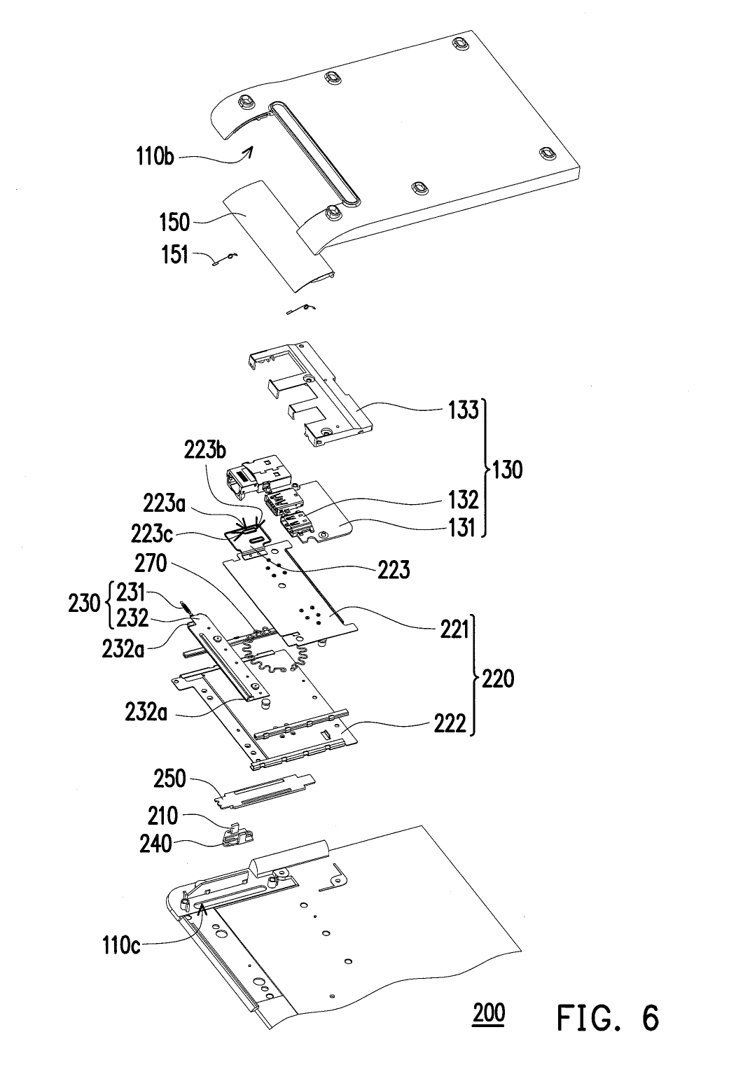

FIG. 6 is a partial exploded schematic view showing an electronic device according to a second embodiment of the present invention. The second embodiment is substantially similar to the first embodiment and thus, the same or similar components are labeled by adopting the same symbols. Referring to FIG. 6, the difference between the first embodiment and the second embodiment lies in that in the second embodiment, an electronic device 200 further includes a first position-limiting component 210. When a driving component 240 is moved to a trigger position A4 (as shown in FIG. 7C) and the elastic component 270 pops up a movable sliding holder 221, such that when the connector module 130 is pushed to the usage position B2, the movable sliding holder 221 is limited by the first position-limiting component 210 during the popping-up process. Additionally, in the second embodiment, the trigger position A4 is between the first position A1 and the second position A3.

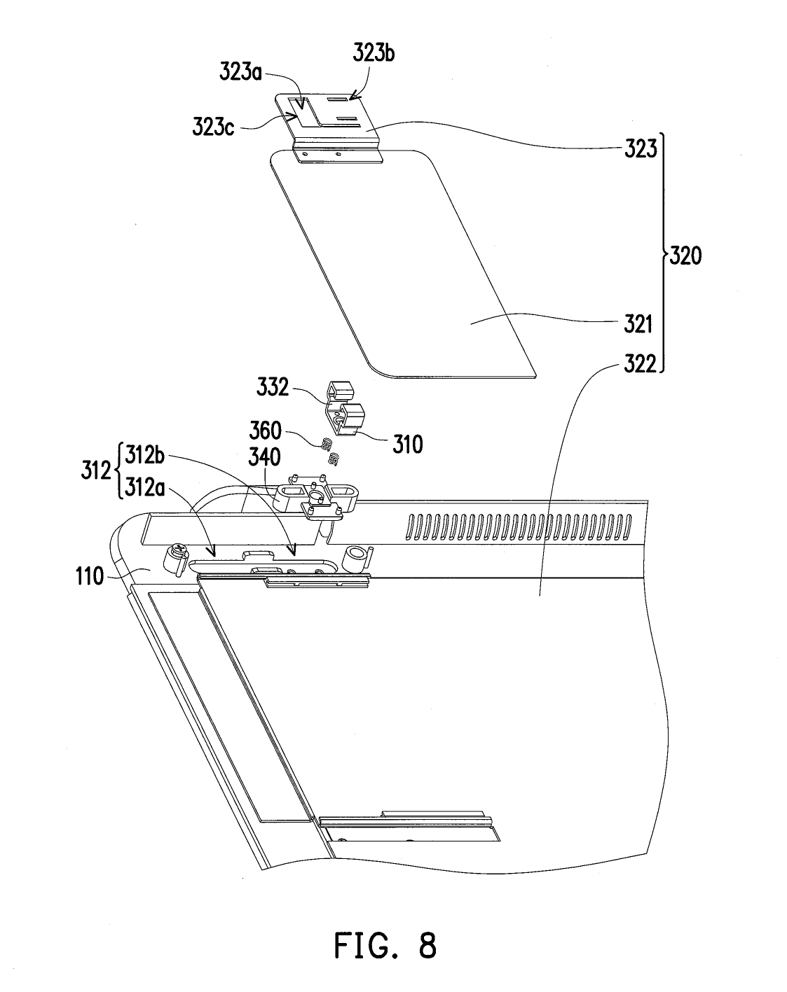

Moreover, the difference between the second embodiment and the first embodiment further includes the electronic device 200 of the second embodiment including a stopper assembly 230 located between the first body 110 and a movable sliding holder 221. The stopper assembly 230 includes a stopper elastic component 231 and a linking component 232. The stopper elastic component 231 is located between the first body 110 and the linking component 232. As shown in FIG. 8, the linking component 232 including a plurality of stopper portions 232a. When the driving component 240 is moved to the trigger position A4 to the second position A3, i.e. moved toward the edge portion 119, the driving component 240 contacts the linking component 232 and drives the stopper elastic component 231 to deform the stopper elastic component 231. At this time, the stopper portion 232a of the linking component 232 leans against and interferes with the movable sliding holder 221 so that the connector module 130 is maintained in the usage position B2.

In particular, the first position-limiting component 210 of the electronic device 200 of the second embodiment is disposed on the driving component 240, and the movable sliding holder 221 further includes a second position-limiting component 223. The second position-limiting component 223 has two second position-limiting portions 223a. In the present embodiment, the driving component 240 integrated with the first position-limiting component 210 is illustrated as an example, but the present invention is not limited thereto. For example, the first position-limiting component 210 may be assembled to the driving component 240 or adhered to the driving component 240.

The first position-limiting component 210 is adaptive to move between a first side 223b and a second side 223c of the corresponding second position-limiting portion 223a. When the driving component 240 is in the first position A1, the first position-limiting component 210 is located at the first side 223b of the corresponding second position-limiting portion 223a. After the first position-limiting component 210 is driven by the driving component 240 to move from the first side 223b to the second side 223c, the first position-limiting component 210 keeps contacting the second side 223c so as to drive the movable sliding holder 221. During the process of the driving component 240 being moved relative to the first body 110 from the first position A1 to the second position A3, when the driving component 240 is moved to the trigger position A4, the elastic component 270 pops up the movable sliding holder 221 from a sliding holder assembly 220 so that the connector module 130 is linked to the usage position B2. At this time, the first position-limiting component 210 leans against the first side 223b of the second position-limiting portion 223a so as to limit the movable sliding holder 221 during the popping-up process.

Referring to FIG. 6, the electronic device 200 of the second embodiment further includes a sliding holder 250 assembled to the first body 110 and located within the range of the second opening 110c. The driving component 240 of the second embodiment substantially slides from the first position A1 to the second position A3 through the sliding holder 250 and is slidably disposed in the two tracks 122a of the fixed sliding holder 122, which is different form the driving component 140 of the first embodiment.

FIG. 7A through FIG. 7D showing the driving component of FIG. 6 in a first position, a transitional position, a trigger position, a second position, respectively. Hereinafter, how the first position-limiting component 210, the second position-limiting component 223 and the stopper assembly 230 in the second embodiment are operated and functioned during the process of the driving component 240 being moved from the first position A1 to the second position A3 will be illustrated with reference to the following drawings. Meanwhile, the drawings are simplified, and the connector module 130 is not shown therein.

First, referring to FIG. 7A, herein, the driving component 240 is located in the first position A1, while the first position-limiting component 210 is located at the first side 223b of the second position-limiting portion 223a. Then, referring to FIG. 7B, herein, the driving component 240 is located in a transitional position A2, while the first position-limiting component 210 is moved from the first side 223b to the second side 223c and contacts the second side 223c so as to drive the movable sliding holder 221.

Afterward, referring to FIG. 7C, when the driving component 240 is pushed to the triggered position A4, the elastic component 270 pops up the movable sliding holder 221 by utilizing the elastic potential energy accumulated during the process of being pushed from the first position A1 to the triggered position A4. At this time, the driving component 240 is still maintained in the triggered position A4, and the first position-limiting component 210 contacts the first side 223b so as to limit the movable sliding holder 221. The connector module 130 on the movable sliding holder 221 is driven to be horizontally moved to the usage position B2 (which is not shown in FIG. 7C).

Referring to FIG. 7D, herein, the driving component 240 is moved from the triggered position A4 to the second position A3, and the first position-limiting component 210 is moved from the first side 223b of the second position-limiting portion 223a to the second side 223c. Returning to FIG. 7C, in detail, the driving component 240 has a first guiding portion 240a, and the linking component 232 has a second guiding portion 232b. When the driving component 240 is moved to the trigger position A4, the two guiding portions 240a and 232b contacts with each other and the driving component 240 applies a pushing force on the linking component 232 so as to move the linking component 232 downward. Since the stopper elastic component 231 is between the first body 110 and the linking component 232, the stopper elastic component 231 is deformed to extend by the force.

Then, referring to FIG. 7D, when the linking component 232 is moved downward, the stopper portions 232a of the linking component 232 lean against the movable sliding holder 221, such that the movable sliding holder 221 is incapable to move, and the connector module 130 is maintained in the usage position B2 (which is not shown in FIG. 7D). Additionally, in the present embodiment, the stopper elastic component 231 also has a repositioning function. When the user pushes the driving component 240 from the second position A3 back to the first position A1, the relationship of the driving component 240 leaning against the linking component 232 is released, and in the meantime, the elastic potential energy accumulated during the process of the stopper elastic component 231 being deformed and extended is also released, such that the linking component 232 returns to its original position.

Further, as the same as the first embodiment, in the second embodiment, while the driving component 240 is pushed from the first position A1 to the second position A3, the movable sliding holder 221 assembled to the driving component 240 is driven, such that the connector module 130 disposed on the movable sliding holder 221 is horizontally moved from the retraction position B1 to the usage position B2. At this time, the cover 150 is further pushed by the protection cover 133 to turn the cover 150 from the closed position C1 to the opened position C2, which may also refer to FIG. 5A and 5B.

FIG. 8 is a partial exploded schematic view showing an electronic device according to a third embodiment of the present invention. The third embodiment is substantially similar to the first and the second embodiments, and thus, the same or similar components are labeled by adopting the same symbols. Additionally, in FIG. 8, only a part of the components of the third embodiment is shown. The main difference between the third embodiment and the second embodiment lies in that the forms of a first position-limiting component 310 and a second position-limiting component 323 of a driving component 320 of an electronic device 300 of the third embodiment. In addition, the electronic device 300 of the third embodiment further includes a locking component 332.

It is to be noticed that in the present embodiment, the locking component 332 has the aforementioned first position-limiting component 310. In other words, the locking component 332 is integrated with the first position-limiting component 310, but the present invention is not intent to limit the form of the first position-limiting component 310, and the first position-limiting component 310 may also be separated from the locking component 332 as two components or may be in any other form that is also capable of position-limiting.

In the third embodiment, the locking component 332 functions as follows. When the driving component 340 is located in the first position A1. The locking component 332 is used for being locked in the second position-limiting component 323. When the driving component 340 receives a pressure, an elastic position-limiting portion 360 is deformed, such that the locking component 332 is separated from the second position-limiting component 323, the driving component 340 is moved relative to the first body 110 from the first position A1 to the second position A3. When the driving component 340 is moved to the second position A3, the pressure is released so that the locking component 332 is again locked in the second position-limiting component 323.

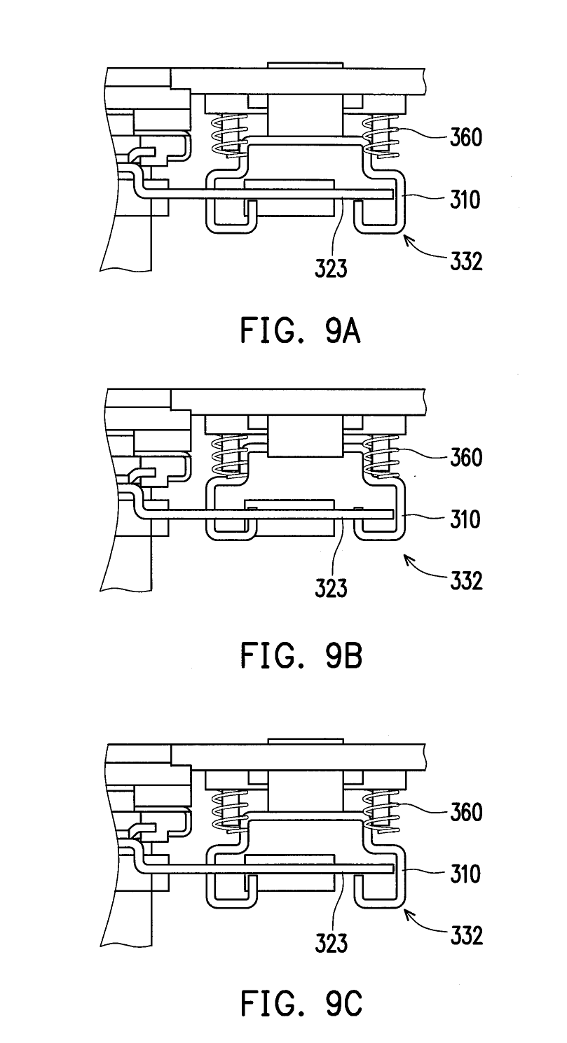

FIG. 9A through FIG. 9C are partial sectional views showing the driving component of FIG. 8 in a first position, a trigger position and a second position, respectively. Referring to FIG. 9A with FIG. 8, in FIG. 9A, the driving component 340 is located in the first position A1, while the second position-limiting component 323 is located at a first side 323b of the second position-limiting portion 323a, and the locking component 332 is locked in the second position-limiting component 323. (Not shown in FIG. 8 and FIG. 9A).

Referring to FIG. 9B with FIG. 8, when the user applies a pressure to the driving component 340, the elastic position-limiting portion 360 located between the driving component 340 and a movable sliding holder 321 is deformed, such that the locking relationship between the locking component 332 and the second position-limiting component 323 is released, and the driving component 340 is pushed from the first position A1 to the trigger position A4. At this time, the elastic component 270 pops up the movable sliding holder 321 by utilizing the elastic potential energy accumulated during the process of the driving component 340 being moved from the first position A1 to the trigger position A4. The driving component 340 is still maintained in the trigger position A4. (Not shown in FIG. 8 and FIG. 9A)

Then, referring to FIG. 9C with FIG. 8, in FIG. 9C, the driving component 340 is located in the second position A3, while the second position-limiting component 323 located at a second side 323c of the second position-limiting portion 323a, and the locking component 332 is locked in the second position-limiting component 323. In the present embodiment, as the same as the first embodiment, the trigger position A4 is substantially the same as the second position A3.

Moreover, referring to FIG. 8, in the present embodiment, the first body 110 has four position-limiting portions 312, wherein the two position-limiting portions 312a thereof correspond to the first position A1 of the driving component 340, and the other two position-limiting portions 312b correspond to the second position A3 of the driving component 340. The position-limiting portions 312 have the same function as the first embodiment, and will not be repeated hereinafter.

Certainly, as the same as the first and the second embodiments, in the third embodiment, when the driving component 340 is pushed from the first position A1 to the second position A3, the movable sliding holder 321 is driven so that the connector module 130 disposed on the movable sliding holder 321 is horizontally moved from the retraction position B1 to the usage position B2. When the driving component 340 reaches the second position A3, the protection cover 133 of the connector module 130 contacts and pushes the cover 150 to turn the cover 150 from the closed position C1 to the opened position C2. Likewise, the process of the cover 150 being turned from the closed position C1 to the opened position C2 may also refer to FIG. 5A and FIG. 5B.

Additionally, if the user wishes to retract the connector module 130 in the first body 110, he/she only requires operating the above-described manner reversely by the following steps. First, a pressure is applied to the driving component 340 on the second position A3 to release the locking relationship between the locking component 332 and the movable sliding holder 321. Then, the driving component 340 is pushed to the first position A1, and the pushing force on the first position A1 is released so as to lock the locking component 332 in the movable sliding holder 321. Of course, when the user reversely moves the driving component 340 from the second position A3 to the first position A1, the cover 150 is repositioned from the opened position C2 back to the closed position C1 by the repositioning elastic component 151.

Though not shown in FIG. 8, the electronic device 300 of the third embodiment is the same as the second embodiment and includes the sliding holder 250 assembled to the first body 10. The driving component 340 substantially slides from the first position A1 to the second position A3 through the sliding holder 250.

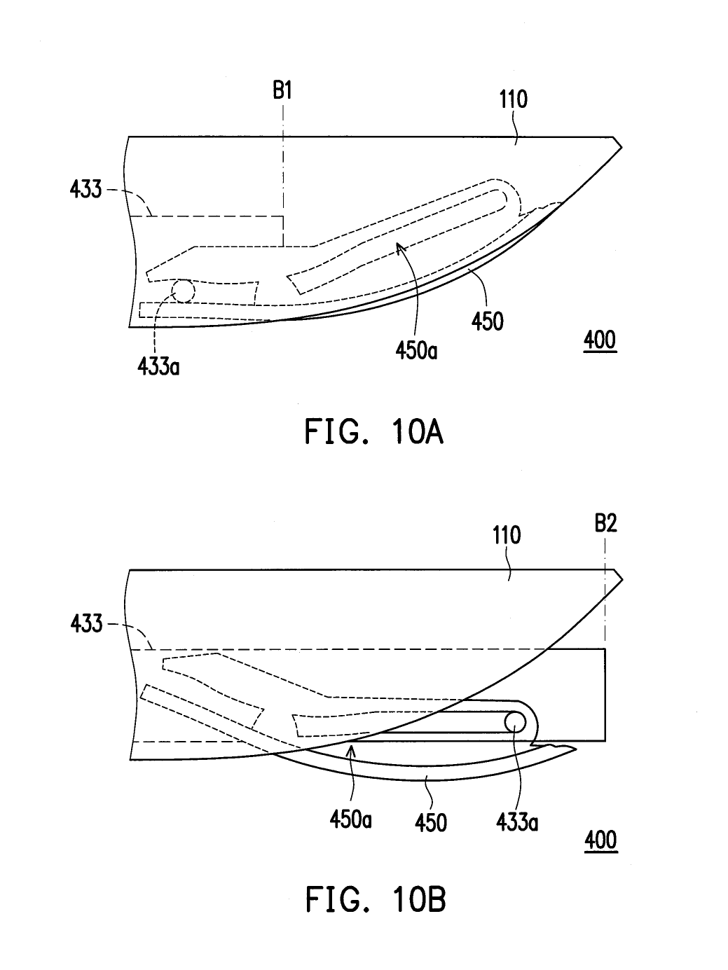

FIG. 10A is a partial side view showing a cover of an electronic device in a closed position according to a fourth embodiment of the present invention. FIG. 10B is a partial side view showing the cover of the electronic device in an opened position according to a fourth embodiment of the present invention. Referring to FIG. 10A and FIG. 10B, the fourth embodiment is substantially similar to the first embodiment through the third embodiment, and thus, the same or similar components are labeled by adopting the same symbols. The difference between the fourth embodiment and the other embodiments lies in that in the fourth embodiment, a protection cover 433 of an electronic device 400 has two first sliding portions 433a, the cover 450 has two second sliding portions 450a corresponding to the two first sliding portions 433a, and the first sliding portions 433a are slidably disposed in the second sliding portions 450a. In the present embodiment, an example where the first sliding portions 433a are used as sliding blocks and the second sliding portions 450a are used as sliding slots is illustrated.

In the previous embodiments, the cover 150 is pivoted to the first body 110, turned relative to the first body 110 by the pushing force generated when the protection cover 133 contacts the cover 150, and repositioned by the repositioning elastic component 151. However, in the fourth embodiment, the protection cover 433 is slidably disposed in the second sliding portions 450a of the cover 450, and thus, during the process of the driving component 430 being moved from the first position A1 to the second position A3, the cover 450 is turned relative to the first body 110 by utilizing the contacting force generated when the first sliding portions 433a contacts the second sliding portions 450a.

Based on the above, in the electronic device of the present invention, the connector module is driven by the driving component to move from the main portion of the first body toward the edge portion, such that the connector module is exposed from the opening of the edge portion. In detail, the connector module is driven by the driving component to drive cover to be opened or closed. When the driving component is moved from the first position to the second position, the cover is driven to turn from a closed position to an opened position. In addition, since the driving component is linked with the movable sliding holder, and the connector module is disposed on the movable sliding holder, the movable sliding holder may be driven by the driving component when the driving component is moved from the first position to the second position so that the connector module disposed on the movable sliding holder is synchronous pushed out of the first body for the user to use. The electronic device may further include elastic components for automatically popping up the connector module during the process that the user indirectly pushing out the cover by using the driving component. Further, in the electronic device of the present invention, the position-limiting portions or the stopper assembly may be used to limit the movement of the driving component or the movable sliding holder, such that the connector module disposed on the movable sliding holder is not possibly moved when being used by the user.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. An electronic device, comprising:
a first body, having a main portion and an edge portion, wherein a thickness of the edge portion is smaller than a thickness of the main portion, and the edge portion has an opening;
a driving component, slidably disposed in the first body; and
a connector module, slidably disposed in the first body and driven by the driving component to move from the main portion toward the edge portion so as to expose the connector module from the opening of the edge portion.

2. The electronic device according to claim 1, wherein the connector module further comprises:
a fixed sliding holder, fixed to the first body;
a movable sliding holder, slidably disposed on the fixed sliding holder;
a circuit board, disposed on the movable sliding holder; and
a connector, disposed on the circuit board.

3. The electronic device according to claim 2, further comprising:
at least one elastic component, disposed between the fixed sliding holder and the movable sliding holder.

4. The electronic device according to claim 2, further comprising:
a stopper assembly, located between the first body and the movable sliding holder, wherein when the connector module is driven by the driving component to move toward the edge portion, the stopper assembly interferes with the movable sliding holder.

5. The electronic device according to claim 4, wherein the stopper assembly further comprises:
an elastic position-limiting portion, located between the driving component and the movable sliding holder.

6. The electronic device according to claim 1, further comprising:
a cover assembly, disposed in the first body and covering the opening of the edge portion.

7. The electronic device according to claim 6, wherein the cover assembly has a repositioning elastic component and a cover, and the repositioning elastic component is linked between the cover and the first body.

8. The electronic device according to claim 6, wherein the cover assembly has a cover, the connector module has at least one first sliding portion, the cover has at least one second sliding portion corresponding to the at least one first sliding portions, and the at least one first sliding portion is slidably disposed in the one second sliding portion.

9. The electronic device according to claim 1, further comprising:
a second body, pivoted to the first body having a keyboard, disposed on the operating surface and having a display.
